(19) United States
(12) Patent Application Publication
(10) Pub. No.: US 2011/0203076 A1
(43) Pub. Date: Aug. 25, 2011

(54) HANDLE FOR A TRANSPORT CART

(76) Inventors: Horst Sonnendorfer, Puchheim (DE); Franz Wieth, Puchheim (DE)

(21) Appl. No.: 13/060,088

(22) PCT Filed: Aug. 21, 2008
(86) PCT No.: PCT/DE2008/001373

§ 371 Date: May 13, 2011

(51) Int. Cl. B62B 5/06

(52) U.S. Cl. 16/110.1

(57) ABSTRACT

A handle for a transport cart has conductive regions. The conductive regions of the handle are located precisely in the regions that provide the user with the most beneficial leverage when maneuvering the transport cart. Those regions are located in the lateral regions of the handle, where the conductive regions of the handle are also located. The conductive regions are in turn connected to the remaining material of the transport cart in a conductive manner.

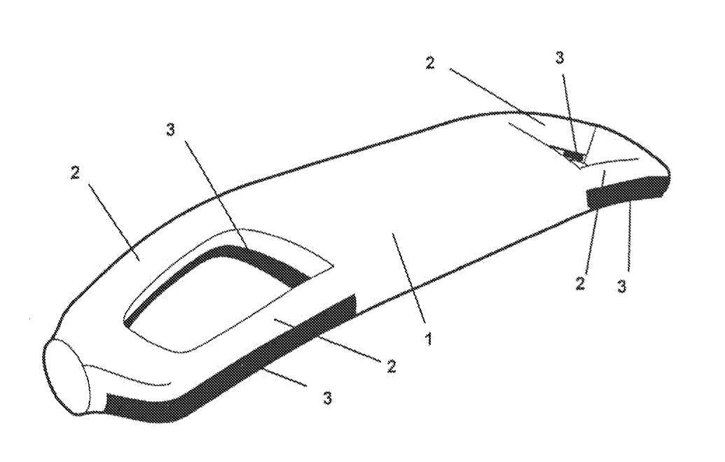

### TECHNICAL FIELD

The invention relates to a handle for a transport cart, which handle has conductive regions. The user of the cart, when pushing the cart, touches these conductive regions and any electrostatic charge which might arise during pushing of the shopping cart is dissipated via the user. This is realized in a manner which is imperceptible and innocuous to the user.

### PRIOR ART

Such a handle for a shopping cart is known from German utility model DE 202004009005 U1.

The known handle is in the form of a handle which has a profile extending homogeneously over its length. The profile has been produced from various materials, using a so-called coextrusion process.

The electrically conducting material is not as resistant to mechanical load as the usual material which is used for handles. In the coextrusion process, it is now possible to use the electrically conducting material which is less resistant to mechanical load specifically for a small region of the profile and to produce the major part of the profile from a material having strong mechanical load-bearing capacity.

A drawback with known handles having electrical conductivity is now the fact that only handles which have a homogeneous profile when viewed over their length are able to be produced.

The known solution for producing handles having electrical conductivity is not applicable to handles which, viewed over their length, do not have a homogeneous profile, but instead have a complex shape produced, for example, by injection molding. Nor can these handles having such a complex shape consist solely of conductive material, since this is not sufficiently resistant to mechanical load.

### DISCLOSURE OF THE INVENTION

### Technical object

The object of the invention is also to equip handles which have a more complex shape and are produced, for example, by injection molding with electrical conductivity, without any loss of stability.

### Technical solution

The considerations which led to the development of the present invention were founded on the fact that there is no need to make the conductive region of the handle extend over its entire length, as is the case in the known handle produced by means of coextrusion.

The stated object has been achieved in that an electrical conductivity is present only in those regions of the handle which are touched by the user as the cart is pushed.

The inventive solution provides that the conductive regions of the handle are located precisely in those regions which provide the user with the most favorable leverages when maneuvering said cart. These regions are located in the lateral regions of the handle.

### Advantageous Effects

The inventive solution has the advantageous effect that, for the handle, a material which is proven in terms of cost, colorfastness and mechanical load bearing is mainly used, and only a small region of the handle has to be equipped with a material which is geared to conductivity, whereby the mechanical drawbacks of the conductive material have no impact on the stability of the handle as a whole.

### BRIEF DESCRIPTION OF THE DRAWINGS

The invention is described in greater detail below with reference to a FIGURE.

The shown handle 1, beyond the actual function of a push handle, satisfies still further functions. In the middle of the handle region, a display area or receptacle for an electronic device can be implemented by way of example, which display area or receptacle, though not shown, is easily imaginable for the person skilled in the art. A deposit lock can also be integrated in this handle.

The user, when pushing, is very likely to grip the handle 1 by one of the lateral, ergonomically shaped holding bars 2, for it is there that the most favorable leverages operate, in a manner advantageous to the user, when he negotiates bends or makes other maneuvers.

The holding bars 2, which are arranged at different heights above the ground, give the user the facility to find the, in each case, individually comfortable position for his hands according to his stature. Elements 3 made of conductive material are respectively present on the holding bars.

These conductive elements 3 are electrically connected to metallic parts of the shopping cart by a connection (not shown here). Advantageously, an electrostatic charging of the shopping cart as a whole, which is theoretically obtained when the shopping cart is pushed, does not therefore arise in the present invention, because the small currents which are generated in the pushing are immediately dissipated via the user who is touching the shopping cart on these conductive elements 3. This preventive dissipation of the small currents is realized in a manner which is wholly imperceptible and innocuous to the user.

The handle 1 can in principle have any chosen shape and can consist of any chosen material. For the implementation of the invention, the handle must merely have the conductive elements 3.

The fastening of the conductive elements 3 can be realized in any chosen manner.

For example, it is possible to produce the conductive elements 3 from a thin material and glue them onto the handle 3, which has the advantage that the glued-on conductive elements 3 do not add to the thickness of the handle, nor do they disturb the feel of the surface. This solution is preferably suitable for retrofitting existing handles with conductive elements 3, and thus for bestowing the advantageous characteristic of preventive dissipation upon the shopping cart as a whole.

It is also possible to produce the conductive elements 3 by means of an applied conductive lacquer. The use of conductive lacquer is likewise well suited to the retrofitting of conductive elements 3 onto existing handles.

In a further possible embodiment, the conductive elements 3 are made of solid material and can be inserted into a recess of the handle 1. The solid, insertable conductive elements 3 can be connected to the handle 1, for example, by a snap-locking or latching connection.

The solid conductive elements 3 can in this case consist of a softer material than the rest of the handle 1, thereby producing a pleasant surface feel for the user.

Basically all materials with which a surface resistance of less than 10 Megaohm can be realized for the conductive regions are suitable as materials for these regions.

Not represented in the drawing, yet at all times comprehensible to the person skilled in the art, an electrically conducting connection exists between the conductive regions of the handle and the remaining parts of the cart. The conducting connection exists preferably to the metal parts of the cart.

The charge which, when the cart is pushed, makes its way into those parts of the cart which act functionally as a capacitor is hence immediately dissipated again and precisely no charging takes place.

### COMMERCIAL APPLICABILITY

The invention is commercially applicable in a wide variety of carts.

1-8. (canceled)

9. A handle for a transport cart, comprising a handle body having a plurality of regions, said plurality of regions consisting of mutually different materials.

10. The handle according to claim 9, wherein said regions include lateral regions of the handle and said lateral regions are conductive regions consisting of a material with increased electrical conductivity relative to a material of the remaining regions.

11. The handle according to claim 10, wherein said conductive regions with increased electrical conductivity have a surface resistance of less than 10 Megaohms.

12. The handle according to claim 10, wherein said conductive regions with increased electrical conductivity are stuck onto remaining parts of said handle body.

13. The handle according to claim 10, wherein said conductive regions with increased electrical conductivity are applied flat on said handle body.

14. The handle according to claim 10, wherein said conductive regions are formed of a solid hard material.

15. The handle according to claim 10, wherein said conductive regions are formed of a soft material.

16. The handle according to claim 10, wherein said conductive regions with increased electrical conductivity are inserted in recesses formed in said handle body.

17. The handle according to claim 10, wherein said conductive regions are inserted in recesses formed in said handle body and retained therein by way of a latching or snap-locking connection.

18. The handle according to claim 10, wherein the transport cart has a chassis, and said conductive regions are electrically conductively connected to the chassis of the transport cart.
